(19) United States
(12) Patent Application Publication
(10) Pub. No.: US 2005/0241497 A1
(43) Pub. Date: Nov. 3, 2005

(54) Food flavoring system and methods

(76) Inventor: Homaro R. Cantu, Chicago, IL (US)

Correspondence Address: Charles C. Valauskas;BANIAK PINE & GANNON, Suite 1200, 150 N. Wacker Drive, Chicago, IL, 60201, US

(21) Appl. No.: 11/118,954

(22) Filed: Apr. 29, 2005

Related U.S. Application Data
(60) Provisional application No. 60/566,778, filed on Apr. 30, 2004.

(51) Int. Cl. A23L 1/00; A47J 9/00

(52) U.S. Cl. 99/494

(57) ABSTRACT

A system and methods for altering the flavor of a food item. The system and methods utilize a flavor alteration utensil having a retainer in which a flavor element may be retained. By engagement with the flavor alteration utensil, the flavor of food managed with the utensil is altered.

This application claims the benefit of U.S. Provisional Application No. 60/566,778 filed Apr. 30, 2004.

### FIELD OF THE INVENTION

The present invention generally relates to a system and methods for the alteration of the flavor of a food item. More specifically, the present invention is directed to systems and methods using simplified utensils by which the flavoring agents can be conveyed to a diner or diners and the flavor of a food item altered during consumption of a food item. Such alteration of the flavor of foods through the use of flavor alteration utensil includes enhancement of the flavor of the food.

### BACKGROUND OF THE INVENTION

The flavor that a diner perceives a food has is a function of a plethora of factors. The type and freshness of the ingredients that are used to make the food play a major role in defining the flavor of a food. The temperature at which a food is served is critical in shaping what a diner perceives the flavor of a food to be. The colors in a cooked food also can alter a diner's perception of what flavor the food has. An additional factor that can shape a diner's perception of the flavor of a food is the aroma and fragrances that surround the immediate environment in which the diner consumes the food. A fragrant flower placed tableside can positively influence a diner's perception of the flavors of the food that the diner consumes.

Many cultures use some form of utensil to assist in the consumption of food. Spoons, forks, and chop sticks are some of the many conventional forms of utensils. Traditional utensils are designed so that a food item may be conveyed to the mouth of a diner efficiently—with little of the food unintentionally dropped or spilled. Traditional utensils intentionally are made from materials that do not impart any flavoring to the foods. Known utensils play no intended role in enhancing or altering the flavor of the food item.

A demand therefore exists for a utensil by which the flavor of food can be altered, including enhanced. The present invention satisfies the demand.

### SUMMARY OF THE INVENTION

The present invention is directed to a system and methods by which a diner's perception of the flavor of a food may be altered by affecting the sense or senses of the diner through the use of a utensil according to the present invention. More specifically, the utensil according to the present invention includes a flavoring retainer with which a flavor element is held. For purposes of this application, a utensil is an apparatus through the use of which a food item may be conveyed to a diner or diners through close or direct contact of the utensil with the mouth of the diner using the utensil. A flavor element can be one or more agents that can provide what is perceived by the diner to be a generally pleasant aroma or an improved or pleasant taste or a generally pleasant touch or view, thereby altering the diner's perception of the flavor of the food. A flavor element can also be one or more agents by which a generally negative reaction to the food is engendered. Such a reaction is necessary for those who may be dieting and seek to wean themselves from, for example, their favorite foods. A flavoring retainer is a portion of the utensil by which the flavor element is positionable so that, during the course of using the utensil, the diner comes in sensory contact with the flavor element or flavoring agents dispersed therefrom. The sensory contact is not only olfactory but also may be visual, tactile, and/or auditory.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will be described in conjunction with the appended drawings provided to illustrate and not to the limit the invention, where like designations denoted like elements, and in which:

FIG. 1 is a side view of a flavor alteration utensil according to the present invention;

FIG. 2 is an overhead view of another embodiment of a flavor alteration utensil according to the present invention; and,

FIG. 3 is a perspective view of another embodiment of a flavor alteration utensil according to the present invention.

### DESCRIPTION OF PREFERRED EMBODIMENTS

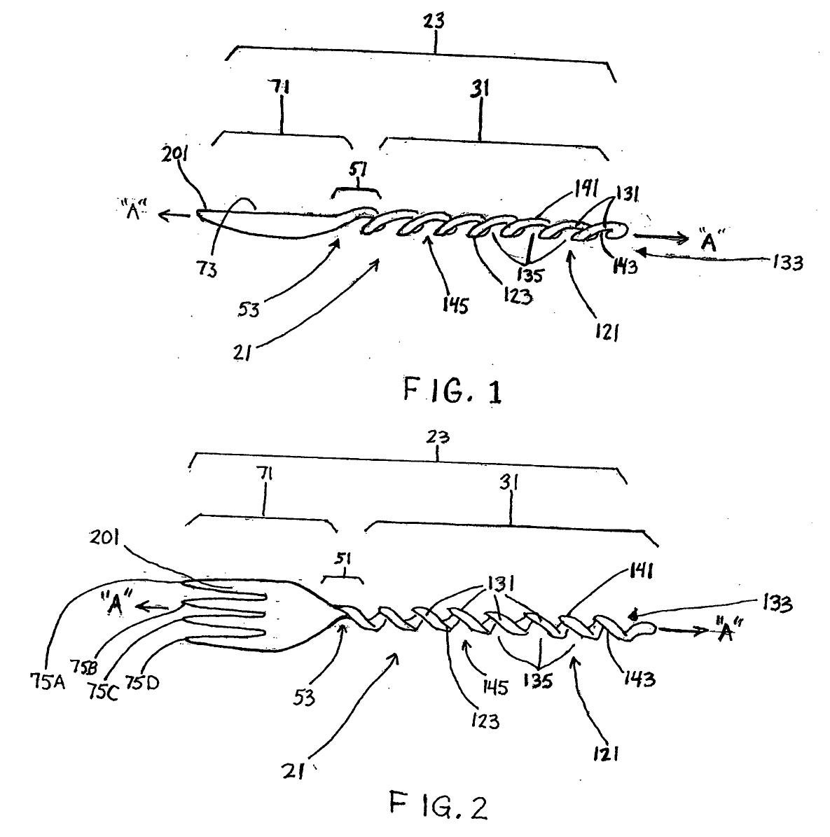

A flavor alteration utensil—also termed simply “utensil” herein—according to the present invention is identified in the appended drawings as 21. The utensil 21 includes a body 23 having a gripping area 31—by which the utensil 21 may be manipulated—and a food management element 71—by which a food item 221 can be managed for consumption such as altered in size or shape and/or retained and conveyed. Some embodiments of the utensil 21 permit the diner to position the food item 221 adjacent to or in contact of the mouth area of a diner thereby permitting the diner to consume it. The utensil 21 includes a flavoring retainer 121 by which a flavor element 151 is positionable during the course of consumption of the food item 221 so that the flavor of the food 221 may be thereby altered. Preferred embodiments of the utensil 21 shown in FIGS. 1-3 include a flavoring retainer 121 having a series of generally uniform coils 131—that may be formed by wrapping the retainer body 123 into a helix-like shape 133, the coils 131 having a generally constant circumference. The flavoring retainer 121 includes a gripping surface 141—by which the diner can grip the flavoring retainer 121 and thereby the utensil 21—and an inner surface 143. Because the generally helical shape 133 has a generally constant circumference, and the individual coils 131 of the preferred embodiments are generally uniform in diameter, the inner surface 143 of the individual coils 131 defines a generally uniform cylindrical cavity 145. The coils 131 of the generally helical shape 133, while generally uniform, are spaced from each other so that gaps 135 open between each of the coils 131. It is through these gaps that access to, for example, the inner surface 143 may be gained for insertion of the flavor element 151 and, for example, from which the flavor element 151 may be visible, or may be dispensed, or touched, or produce flavor agents into, for example, the immediate environment.

FIG. 1 is a side view of one preferred embodiment of the utensil 21. The FIG. 1 embodiment of the utensil 21 is generally aligned along a single axis “A”. The food management portion 71 of the FIG. 1 embodiment includes a concave portion 73 so that the utensil 21 may be used as a spoon or scoop.

FIG. 2 is an overhead view of another preferred embodiment of the utensil 21. The FIG. 2 embodiment of the utensil 21 is also generally aligned along a single axis “A”. The food management portion 71 of the FIG. 2 embodiment includes tines 75A-D so that the illustrated embodiment may be used as a fork.

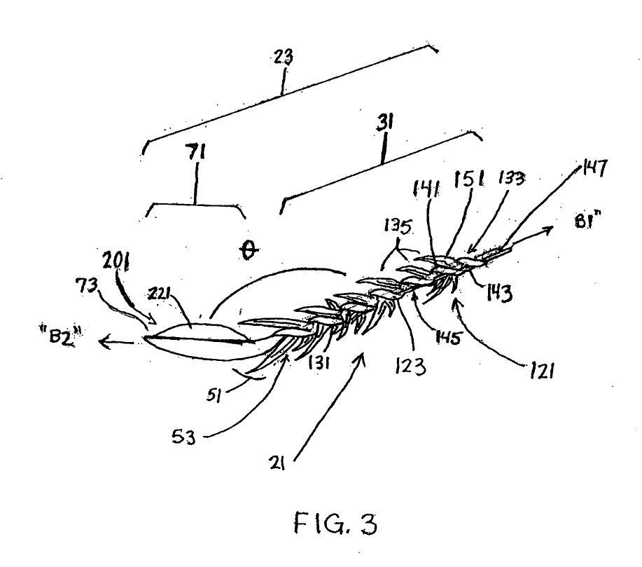

FIG. 3 illustrates another preferred embodiment of the utensil 21. While the food management portion 71 of the FIG. 3 embodiment includes a concave portion 73 so that the utensil may be used as a spoon, the FIG. 3 embodiment, like the other illustrated embodiments, may include food management portions 71 that are of different shapes and sizes to permit a wide range of food management, including consumption of a variety of food items. For example, the food managing portion 71 may be sized and shaped as a knife, a “spork”, stirrer, or chopstick. Rather than generally aligned along a single axis “A”—as are the preferred embodiments shown in FIGS. 1 and 2—, the utensil 21 shown in FIG. 3 includes a gripping area 31 aligned along an axis “B1” and a food management portion 71 aligned along an axis “B2” such that an angle θ is formed between the two axes B1 and B2. A utensil 21 having a plurality of axes, such as the one illustrated in FIG. 3, is particularly advantageous for purposes of altering the flavor of a food item 221 through aroma because the angle θ at which the gripping area 31 is relative to the food management portion 71 allows the diner to come into even more direct contact with the flavor element 151. For example, if the flavor element 151 is a fragrant herb—such as rosemary, thyme, or cilantro—, because the flavor element 151 is closer to the nose of the diner as he or she draws the utensil to his or her mouth, the diner will more easily be able to smell the flavor agents being emitted from the element 151. The angle θ may be of various degrees depending on the flavoring agents 151 (e.g., fragrance) of the flavor element 151. However, a θ between 120 degrees to 145 will permit a flavor element 151 of even moderate fragrance to create a sufficient aroma that may be encountered by a diner having a generally average olfactory sense during the course of consuming food 221 with the utensil 21.

FIG. 3 illustrates one use of the utensil 21. A flavor element 151 has been threaded through the flavoring retainer 121—such as by inserting the flavor element 151 first through an opening 147 and into the cavity 145. The gaps 135 between the individual coils 131 permit the diner to see the flavor element 151 and, if the flavor element 151 extends near or above and beyond the gripping surface 141, to touch the flavor element 151 and, if the flavor element 151 has an aroma, to smell the aroma that escapes in the atmosphere immediately surrounding the utensil 21. When a diner draws the utensil 21 close to his or her face in order to consume the food item 221, the diner makes sensory contact with the flavor element.

The utensil 21 may be used by those seeking to dislike certain foods or generally food such as those that choose to or must diet. The utensil 21 may include a flavor element 151 that imports a not necessarily positive experience to the diner so that the diner will come to associate the bad experience with possibly the diner's favorite foods and grow to dislike the food and grow to like other foods (served with a utensil 21 having a flavor element 151 that imports a good flavor to the food) which the diner should be eating.

The utensils 21 may be made from a variety of materials that can facilitate the consumption of a food item 221. Examples of preferred materials from which the utensil 21 may be made include metal—for example, one that imparts no flavoring to the food item 221 such as a stainless steel or a plated metal or alloy. The metal can be uncoated or coated such as with a material that prevents the food item from sticking to the surface 201. An example of such coating material is Teflon®. One part or all of the utensil 21 may also be made from sufficiently flexible to permit the utensil 21 to be bent or the shape otherwise arranged to accomplish the objectives of the invention. For example, with respect to the FIGS. 1-3, the area 51 of the utensil at which the gripping area 31 is joined to the food management portion 71 may be made from a particularly flexible material or a sufficiently thin amount of material so that the area 51 forms a joint 53 and allows the utensil 21 to be bent there.

1. A flavor altering utensil, said utensil comprising:
a food management portion;
a gripping portion;
said gripping portion including a flavoring retainer with which a flavor element may be retained for altering flavor of a food item, said flavoring retainer including a helical shape and a series of coils; and
said flavoring retainer having an inner surface, said inner surface sized and shaped for receipt of said flavor element.

2. The flavor altering utensil according to claim 1 wherein said helical shaped series of coils are of generally uniform size and shape.

3. The flavor altering utensil according to claim 2 wherein said inner surface of said flavoring retainer is sized and shaped as a generally uniform cylindrical cavity.

4. The flavor altering utensil according to claim 1 wherein said food management portion and said gripping portion are aligned generally along a common axis.

5. A utensil for altering flavor of a food item, said utensil comprising:
a food management portion for managing the food item, said food management portion aligned at a food management portion axis;
a gripping portion aligned along a gripping portion axis;
said food management portion axis positioned relative to said gripping portion axis at angle of less than 180°; and
said gripping portion including a flavor retainer sized and shaped for insertion of a flavor element for altering the flavor of a food item.

6. The utensil according to claim 5, wherein said flavor retainer includes a generally helical shaped set of coils.

7. The utensil according to claim 6, wherein said helical shaped set of coils includes an inner surface into which the flavor element can be inserted.

8. A method by which a consumer may alter flavor of a food item, said food flavor altering method comprising:
inserting a flavor altering element in a flavoring retainer formed as a part of a flavor alteration utensil, the flavor alteration utensil including a food management portion by which the food item may be managed by the consumer and a gripping portion by which the consumer may grip the flavor alteration utensil (the gripping portion including the flavoring retainer in which the flavor altering element is inserted); and
engaging the flavor alteration utensil so that the flavor of the food is altered for the consumer.

9. The food flavor alteration method according to claim 8, wherein said insertion step includes also positioning the flavor altering element within the flavor retainer so that the consumer comes into contact with the flavoring altering element upon said engaging of the flavor alteration utensil.
